(19) United States
(12) Patent Application Publication
(10) Pub. No.: US 2013/0199974 A1
(43) Pub. Date: Aug. 8, 2013

(54) Device for Purifying a Liquid

(71) Applicants: Joseph Lvovich Shmidt, New York, NY (US); Gleb Dmitrievich Rusinov, Saint-Petersburg (RU); Alexey Leonidovich Kuzmin, Saint-Petersburg (RU)

(72) Inventors: Joseph Lvovich Shmidt, New York, NY (US); Gleb Dmitrievich Rusinov, Saint-Petersburg (RU); Alexey Leonidovich Kuzmin, Saint-Petersburg (RU)

(73) Assignee: ELECTROPHOR, INC., Dobbs Ferry, NY (US)

(21) Appl. No.: 13/818,601

(22) PCT Filed: Aug. 24, 2011
(86) PCT No.: PCT/RU2011/000638

§ 371 Date: Apr. 17, 2013

(30) Foreign Application Priority Data
Sep. 2, 2010 (RU) 2010137659

(51) Int. Cl. C02F 1/00

(52) U.S. Cl. CPC C02F 1/003
USPC 210/104; 210/137

(57) ABSTRACT

A device for purifying a liquid is disclosed. The device includes a collecting vessel for an unpurified liquid, a collecting vessel for a purified liquid, a replaceable filter module filled with a filter material and an automatic means for timed injection of air into the collecting vessel for the unpurified liquid during a filtration process. The automatic means is connected to the collecting vessel for the unpurified liquid by an injection nozzle having a pressure control valve. Moreover, the automatic means is for maintaining positive air pressure above the unpurified liquid during the filtration process. Maintenance of positive air pressure during the filtration process increases filtration speed of the liquid with simultaneous increase in degree of purification of the liquid.

### FIELD OF THE INVENTION

The invention relates to devices for purifying a liquid, preferably drinking water, intended for use as self-contained devices in everyday application, in the country and garden plots and in service departments. In particular, this invention relates to self-contained devices subjecting the certain water portions to pressure treatment.

The invention can find its application for purifying drinking water and other liquids for everyday application, in medicine and other industries.

### PRIOR ART

Known are devices for purifying liquids with gravity feed. Jugs/water-bottles and vessels of large volume into which water to be treated is poured from a cock, for example, can serve as an example of these devices. Usually systems of this type have a collecting vessel for the unpurified liquid and a collecting vessel for the purified liquid, a replaceable filter module filled with a filter material. As a rule, ion exchanger and activated carbon are used as filter materials. Principle of operation of such devices for purifying a liquid is a very simple: a liquid is poured into a collecting vessel for the unpurified liquid, by gravity it flows through a filter module and comes into a collecting vessel for the purified liquid. As a rule, coarse dispersive sorbents are used in the devices with gravity feed. It is known that fine dispersive sorbents, for example, activated powder carbon or ion-exchange powder resin, as well filter materials of fine purification, for example, hollow-fiber, membrane and carbonblock elements have a high sorption kinetics leading to improvement of purifying properties of the filter element. However using of the enumerated filter materials in the devices with gravity feed can lead to decreasing of filtration speed right until a liquid can stop flowing through the filter module at all, because pressure created by column of liquid above the module is not enough to overcome the total hydraulic resistance of the filter material. For the most effective filtration or water purification it is reasonably to provide a contact of a liquid with the filter material on as large as possible area, accordingly forced subjecting a liquid to maximum intensive and entire process of adsorption to remove impurities existing in it.

In prior art this problem was partly solved by creating the self-contained pressure devices for purifying a liquid. In such devices a liquid forced flows through the filter at the expense of the difference between air pressures created between a collecting vessel for the unpurified liquid and a collecting vessel for the purified liquid, i.e., between input and output sides. Such devices for purifying liquids are well known.

For example, it has been proposed the device for purifying water according to the U.S. Pat. No. 7,507,338 (Filtrex Holdings Pte Ltd (SG), published Mar. 24, 2009, C02F 1/28, 1/44 1/50), including a collecting vessel for the unpurified water, a cover with built-in manual pump, a multi-step filter module and a sealing element arranged between a cover and a neck of a collecting vessel. A sealing element provides leak-proofness within a vessel necessary for creating positive air pressure above the level of the unpurified water under action of which water from a collecting vessel for the unpurified water is forced through the filter module upwards. A pump, a filter module, a means (cock) for the purified water to exit and a sealing element are set in a cover in such a way that a cover can be used separately with various water vessels and containers having a neck suitable for its installation. Principle of operation is based on injecting air into the upper part of a collecting vessel above the level of the unpurified water. Compressed air pushes water out through a filter module and further through a means for the purified water to exit for use.

It has been proposed the device for purifying a liquid essentially drinking water according to U.S. Pat. No. 7,413,653 (James Dennis Powell (US), published Aug. 19, 2008, B01D 29/56, C02F 1/00). The device removes undesirable suggestions, odors and contaminating impurities from drinking water and intended for use in trips, in the country, out-of-town areas. The device consists of a water container, a filter and a cover. There are two holes on the cover; one hole is intended for a hand-operated air piston pump, the second hole is intended for a cock supplying the purified water for use. By lowering and lifting the piston with a hand some times, a consumer injects air into the upper part of the container. At the expense of the compressed air pressure the unpurified water flows through the filter. When opening the cock knob by a consumer the purified water is supplied for use.

The closest analog of the invention to be filed is a jug for filtering a liquid according to U.S. Pat. No. 5,225,078 (Ametek, Inc., published Jul. 6, 1993, B01D 27/02). A jug for filtration is used in every day conditions for purifying water. Jug has the body 11 for the purified water with a handle 15 and a draining beak 16, a collecting vessel 12 for the unpurified water separated to the upper part 24 and the lower part 23 by the bellows 40, a filter element 13 arranged in the lower part 23 of a collecting vessel, and a cover 14 closing the upper part 24 of a collecting vessel 12 with a screw joint. Cover 14 has a hole 41 for equalization of air pressure (FIG. 2). Filter element 13 is replaceable and mounted in the lower part 23 of the collecting vessel 12. There is a rubber seal 30 between the filter element 13 and the lower part 23 of the collecting vessel. Bellows 40 is hermetically connected to the filter element 13 (it is weld to the upper part of the carbonblock disc along its perimeter) at the expense of this when pushing on the cover 14 with hand (the hole 41 should be closed with palm of the hand) pressure differential creates above the level of the unpurified liquid in the collecting vessel assisting in its flowing through the filter element 13. Bellows 40 is made from a rubber material. Bellows 40 can be also arranged between the upper part 24 of the collecting vessel and the lower edge of the cover 14. In this case pressure differential will be created when a consumer pushes with hand on the elastic area 43 in the central part of the cover 14 (prototype).

A drawback of pressure devices for purifying a liquid discussed in prior art is that the positive air pressure created by the air injection means above the level of the unpurified liquid is not stable and does not ensure uniform and stable flowing of a liquid through the replaceable filter module during filtration cycle. This is caused by that a consumer is not able to control a degree of his physical efforts produced by him in periodic mechanical action to the injection means throughout the entire filtration cycle. In this case on the term “filtration cycle” one should understand a flowing period of one purified liquid portion from the vessel for the unpurified liquid through the replaceable filter module into the vessel for the purified liquid. Unstable positive air pressure created by the injection means also can lead to non-uniform flowing of the liquid through the replaceable filter module, i.e., to ineffective use of the filter material and, accordingly, to decreasing the liquid purification degree.

Besides, operation of the devices for purifying a liquid described in prior art will entail the expenditures of certain physical efforts on the consumer's part, such devices are not enough convenient in use.

All above considered, this invention is an attempt to react to the abovementioned problems known for today and to solve them.

The general object of the invention and required technical result achieved in using the invention is the development of a new device for purifying a liquid, in particular drinking water and increasing the liquid filtration speed with simultaneous increasing the degree of liquid purification.

An additional object of the invention is an improvement of the operating characteristics of the device for purifying a liquid in comparison with the prototype.

The proposed object and required technical result in using the invention is achieved by that the device for purifying a liquid provided with an air injection means comprising a collecting vessel for the unpurified liquid, a collecting vessel for the purified liquid, a replaceable filter module filled with a filter material according to the invention is designed to maintain positive air pressure above the level of the unpurified liquid throughout the entire filtration cycle, comprises an automatic means for the timed injection of air during the filtration regime connected to a collecting vessel for the unpurified liquid by means of an injection nozzle having a pressure control valve, wherein the automatic means for the timed injection of air includes a pneumatic pump, a control unit, a power supply, a liquid level sensor and at least one feedback means, wherein input of the pneumatic pump is communicated with atmosphere, output of the pneumatic pump is connected to the input of the control unit designed to define the sequence and temporal operation modes of the pneumatic pump during the filtration regime, output of the control unit is connected to the input of the supply unit and a liquid level sensor and at least one feedback means are connected to the control unit, and that a pressure pickup or a current sensor or an effort sensor or any their possible combination is used as a feedback means, and that an air microcompressor or a membrane micropump is used as a pneumatic pump, and that a regulating pressure valve is used for releasing positive air pressure within the collecting vessel for the unpurified liquid on finishing the filtration cycle, and that a liquid level sensor is intended for automatic switching off the pneumatic pump in dependence on the level of the unpurified liquid, and that a liquid level sensor is used for automatic switching off the pneumatic pump at the minimal level of the unpurified liquid, and that a feedback means is intended for maintaining the magnitude of the positive air pressure above the level of the unpurified liquid within the range of 0.1-1.0 bar, preferably, 0.15-0.5 bar, and that a float sensor, a conductance sensor or a contactless sensor is used as a liquid level sensor, and that an injection nozzle is additionally provided with a protection valve intended for equalizing the positive pressure, and that an air purification filter is additionally arranged at the input of the pneumatic pump, and that a collecting vessel for the purified liquid additionally comprises a heating element, and that a collecting vessel for the purified liquid additionally comprises an ultra-violet source, and that a collecting vessel for the purified liquid additionally comprises a mineralization means, and that granulated activated carbon, powder activated carbon, granulated ion-exchange resin, powder ion-exchange resin, activated carbon fibers, polymer ion-exchange fibers, membrane filtration elements, hollow-fiber filtration elements, and carbonblock filtration elements or any their combination are used as a filter material for a replaceable filter module, and that a filter material for the replaceable filter module additionally comprises a bactericide additive.

### BRIEF DESCRIPTION OF THE DRAWINGS

Essence of the invention is explained by the drawings.

FIG. 1 shows a general view of the device for purifying a liquid.

FIG. 2 shows the upper part of the device for purifying a liquid.

FIG. 3 shows a general scheme of the device for purifying a liquid. The adopted convention: water ______, air_._._, functional connections . . . .

FIG. 4 shows a general scheme of the device with a heating element additionally arranged in a collecting vessel for the purified liquid. The adopted convention: water ______, air_._._, functional connections . . . .

FIG. 5 shows a general scheme of the device with the ultra-violet source additionally arranged in a collecting vessel for the purified liquid. The adopted convention: water ______, air_._._, functional connections . . . .

FIG. 6 shows a general scheme of the device with a mineralization means additionally arranged in a collecting vessel for the purified liquid. The adopted convention: water ______, air_._._, functional connections . . . .

FIG. 7 shows a general view of the device for purifying a liquid in the moment of starting the filtration cycle.

### REALIZATION OF THE INVENTION

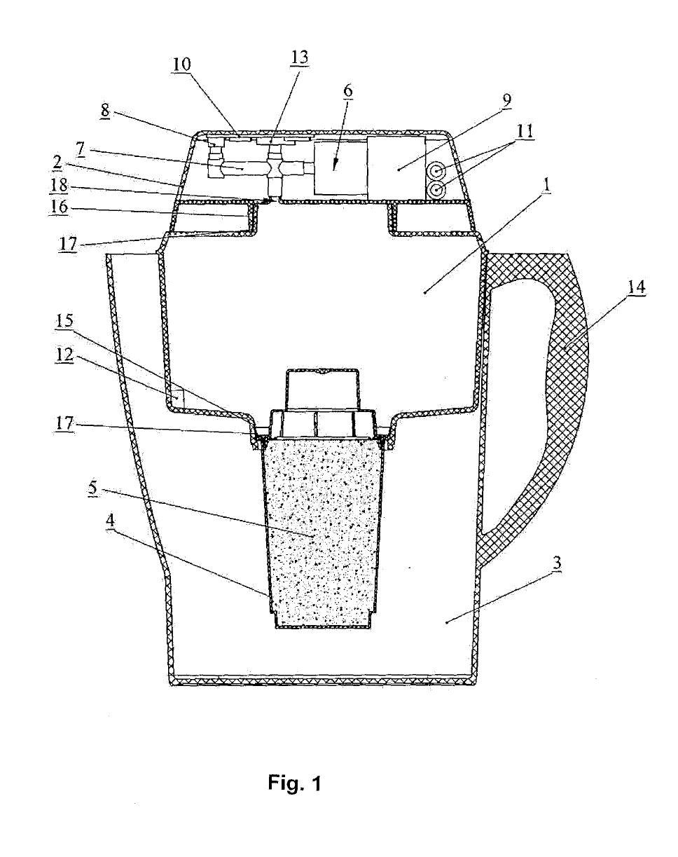

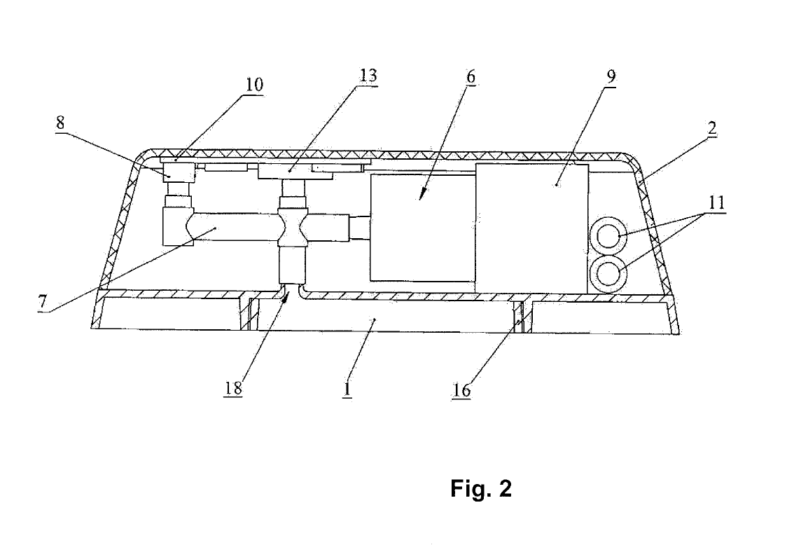

Device for purifying a liquid comprises a collecting vessel 1 for the unpurified liquid with a removable cover 2, a collecting vessel 3 for the purified liquid, a replaceable filter module 4 filled with a filter material 5 and an automatic timed means 6 for air injection during the filtration regime (automatic injection means), (FIG. 1).

Automatic injection means 6 injects air inside the collecting vessel 1 creating the positive air pressure above the level of the unpurified liquid throughout the entire filtration cycle, i.e. during flowing of one unpurified liquid portion from the collecting vessel 1 for the unpurified liquid through the replaceable filter module 4 into the collecting vessel 3 for the purified liquid. Automatic injection means 6 is connected to the collecting vessel 3 for the purified liquid by means of the injection nozzle 7 provided with the regulating pressure valve 8 (FIG. 1, 2).

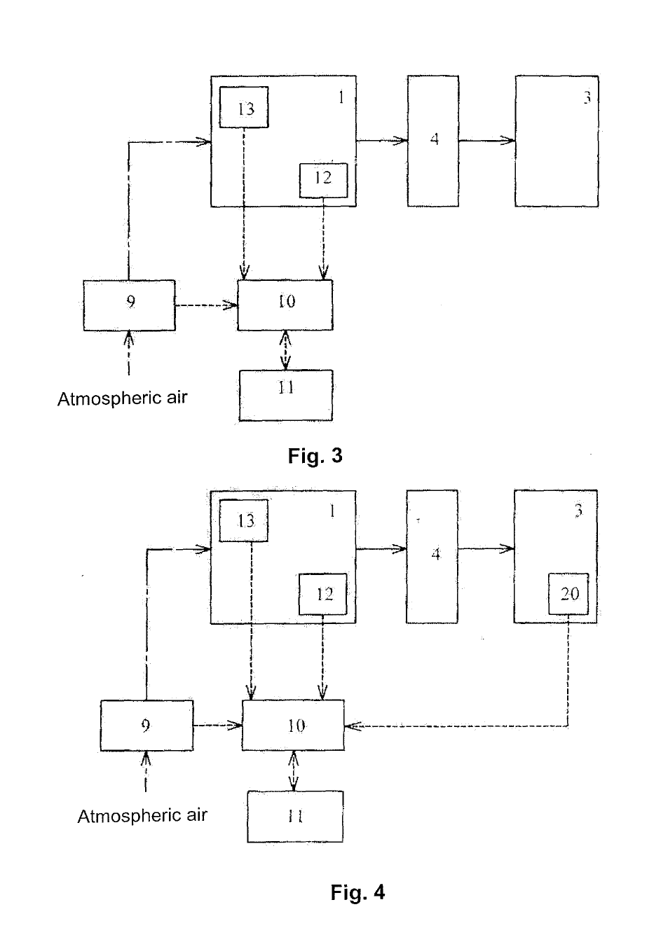

Automatic injection means 6 of the timed air injection includes an injection pump 9, a control unit 10, a supply source 11, a liquid level sensor 12 and at least one feedback means 13, wherein input of the automatic injection means 6 is communicated with atmosphere (FIG. 3). On the term “communicated with atmosphere” one should understand that the injection pump 9 has a pressure close to atmospheric one at the input. Output of the injection pump 9 is connected to the input of the control unit 10, output of which is connected to the input of the supply source 11, a liquid level sensor 12 and at least one feedback means 13 are connected to the control unit 10 designed to define the sequence and temporal operation modes of the pneumatic pump 9 during the filtration regime. Definition of the sequence and temporal operation modes of the pneumatic pump 9 is carried out for example by means of the programmable microcontroller arranged in the control unit 10, and stabilization of the positive air pressure above the level of the unpurified liquid is carried out by means of the feedback algorithms using the feedback means and other sensor or means converting the magnitude of the positive air pressure into a signal for transmitting to the control unit 10. Availability of the specified functional connections provides the normal functioning of the automatic injection means 6 and its protection against possible malfunctions during operation.

The device elements such as a handle 14 or a cover 2 have air cavities which are filled with atmospheric air. Accordingly, the injection pump 9 can be arranged both in the handle 14 (not shown in the drawings) and in the cover 2 of the device (FIG. 1), and also in any its part where there is always atmospheric air, for example, on the body of the vessel 3 for the purified liquid (not shown in the drawings) or on the cover 2 (not shown in the drawings). For example, an air microcompressor or a membrane micropump is used as the injection pump 9.

Automatic injection means 6 is provided with at least one feedback means 13 intended for maintaining the magnitude of the positive air pressure above the level of the unpurified liquid within the range of 0.1-1.0 bar, preferably, 0.15-0.5 bar. A pressure pickup or a current sensor or an effort sensor or any their possible combination is used as a feedback means 13. If a pressure pickup is used as the feedback means 13 it can be incorporated into the injection nozzle 7 (FIG. 1). If a current sensor is used as the feedback means 13 it can be arranged, for example, within the control unit 10, namely, on the board of the microprocessor unit (not shown in the drawings). Maintaining the magnitude of the positive air pressure above the level of the unpurified liquid within the specified pressure range assists in uniform and stable flowing of a liquid through the replaceable filter module 4 and allows increasing the liquid filtration speed throughout the entire filtration cycle.

For example, when using a pressure pickup it is possible to maintain the magnitude of the positive air pressure above the level of the unpurified liquid within the specified pressure range at the expense of the periodic automatic switching-on and switching-off of the pneumatic pump 9 in response to a signal from the pressure pickup depending on the magnitude of positive air pressure. For example, automatic switching-off of the pneumatic pump 9 occurs at the magnitude of the positive air pressure of ≧1.0 bar, preferably ≧0.5 bar, and automatic switching-on of the pneumatic pump 9 occurs at the magnitude of the positive air pressure of ≦0.1 bar, preferably ≦0.15 bar. In similar manner it is possible to maintain the magnitude of the positive air pressure in response to a signal from an effort sensor and a current sensor. A current sensor, for example, arranged on the board of the microprocessor unit (not shown in the drawings) reacts to the change of the current strength in the electric circuit. The more the magnitude of positive air pressure, the more intensive the pneumatic pump 9 operates and accordingly the more current strength will be. At preset range of the excess pressure, the current sensor will fix the corresponding preset threshold values of current strength value and apply a signal of switching-off of the pneumatic pump 9 to the control unit 10. In this case switching-on of the pneumatic pump 9 will be carried out automatically in the preset period of time, for example, in response to a signal from the microprocessor unit arranged in the control unit 10. An effort sensor arranged, for example, within the pneumatic pump 9 (not shown in the drawings) reacts to the change of the rotational force of the pneumatic pump 9 motor. The more the magnitude of positive air pressure, the more intensive the pneumatic pump 9 operates and accordingly rotational force of the motor increases. At preset range of the excess pressure, the effort sensor will fix the corresponding preset threshold values of effort magnitude and apply a signal of switching-off of the pneumatic pump 9 to the control unit 10. In this case switching-on of the pneumatic pump 9 will be carried out automatically in the preset period of time, for example, in response to a signal from the microprocessor unit arranged in the control unit 10. Also, it is possible to use various combinations of the abovementioned sensors. For example, a combination of a current sensor and a pressure pickup or a combination of an effort sensor and a pressure pickup. In this case, for example, a current sensor or an effort sensor will apply a signal of switching-off of the pneumatic pump 9 to the control unit, and accordingly a pressure pickup will apply a signal of switching-on.

Thus, by means of periodic switching-on/switching-off of the pneumatic pump 9 in response to a signal from the feedback means 13 it is possible to maintain the magnitude of the positive air pressure above the level of the unpurified liquid within the specified pressure range, namely, 0.1-1.0 bar preferably 0.15-0.5 bar which assists in uniform and stable flowing of the unpurified liquid, unlike the prototype, through the volume of the filter material 5 including fine dispersive sorbents and filter materials of fine purification throughout the entire filtration cycle.

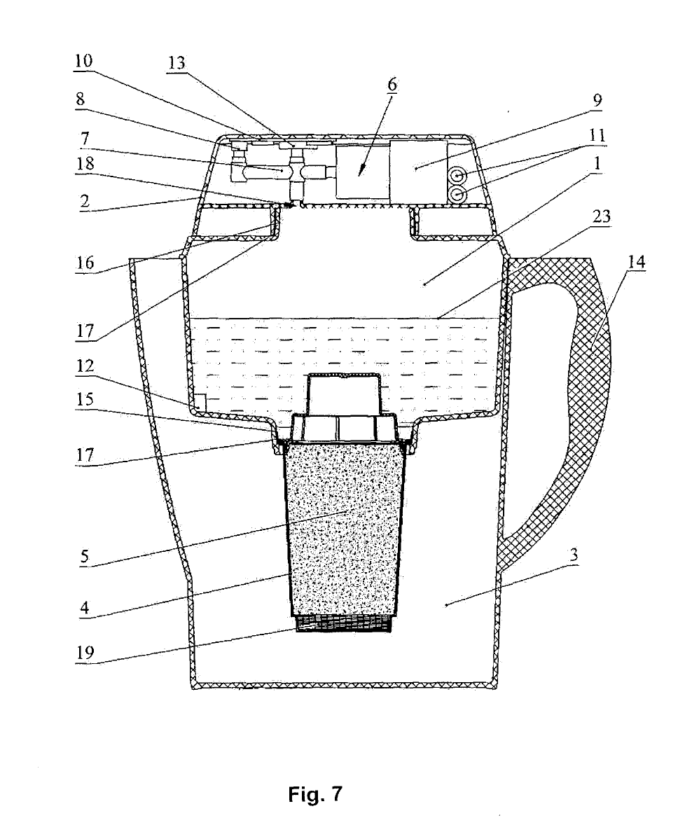

Automatic injection means 6 is provided with a liquid level sensor 12 designed for automatic switching-on/switching-off of the pneumatic pump 9 depending on the level 23 of the unpurified liquid, preferably at a minimal level of the unpurified liquid, (FIG. 7). On the term “minimal level” one should understand a level at which practically all unpurified liquid collected in the vessel 1 has been filtered through the module 4 (not shown in the drawings). Accordingly, automatic switching-off of the pneumatic pump 9 occurs in the moment of finishing the filtration process. This is necessary that not to allow ingress of air into the replaceable filter module 4 and not to allow formation of air bubbles and air gaps in the volume of filter material 5 which can lead consequently to ineffective operation of the replaceable filter module.

A float sensor, an electric conductance sensor, a contactless sensor can be used as a liquid level sensor 12. A liquid level sensor 12 can be mounted in the lower part of the collecting vessel 1 (FIG. 1) and connected to the supply source 11 through the control unit 10 by means of the current leads (not shown in the drawings).

The control unit 10 can be arranged in the cover 2 (FIG. 1) or in the handle 14 (not shown in the drawings) of the device for purifying a liquid. The control unit 10 can be, for example, a microprocessor unit (microcontroller) arranged on the board comprising an energy-dependent data memory, a real time counter and a calculator. Additionally, the control unit 10 can include an information display device (display, light diode or graphical screen, means for applying an audible signal and so on) sending the current information of the operation process and status of the device, for example, the current resource of the device, the magnitude of positive air pressure within the collecting vessel 1 to a consumer. Also, the control unit 10 can additionally include “switching-on” and “switching-off” buttons respectively for starting and stopping filtration process, as well the “resource reset” button usually used for zeroing the resource in substituting an old filter module for a new one. The information display device and functional buttons can be arranged on the external side of the device directly accessible to a consumer. For example, the enumerated elements can be brought out on the external surface of the cover 2 by means of the current leads (not shown in the drawings).

The collecting vessel 1 has the lower neck 15 designed for mounting a replaceable filter module 4, and the upper neck 16 designed for filling-in a liquid. The upper neck 16 for filling-in a liquid can be closed from above both by means of the cover 2 of the device, for example, by means of a screw joint, a bayonet joint and by latching, and by means of the special separate cover (not shown in the drawings). Mounting of the replaceable filter module 4 in the lower neck 15 also can be carried out by means of a screw joint, a bayonet joint and by latching. The lower neck 15 and the upper neck 16 are provided at least with one sealing means 17 which contains air within the collecting vessel 1 allowing creating positive pressure above the level of the unpurified liquid. The injection nozzle 7 can be connected to the collecting vessel 1 through the opening in its upper part (not shown in the drawings), through the opening in the upper neck 16 (not shown in the drawings), or through the opening 18 in the cover 2 (FIG. 1,2).

The automatic injection means 6 is connected to the collecting vessel 1 for the unpurified liquid by means of the injection nozzle 7 provided with a pressure regulating valve 8.

The pressure regulating valve 8 is intended for equalizing the positive air pressure within the collecting vessel 1 in the moment of finishing of the filtration process. Also, it can perform a function of the protection valve for ensuring the possibility of eliminating a critical positive air pressure within the collecting vessel 1 in the case of the possible malfunction in operation of the automatic injection means 6. The regulating valve 8 may be arranged, for example, in the cover 2 (FIG. 1), in the handle 14 (not shown in the drawings) or on the side wall of the collecting vessel 1 (not shown in the drawings). The protection valve can be mounted on the injection nozzle 7 as a separate element (not shown in the drawings) for eliminating a critical positive air pressure within the collecting vessel 1 in the case of the possible malfunction in operation of the automatic injection means 6.

The supply unit 11 can be arranged, for example, in the cover 2 (FIG. 1) or in the handle 14 of the device for purifying a liquid (not shown in the drawings). For example, a supply battery or a storage battery can serve as the supply source 11.

The injection nozzle 7 can be made from a polymer material. Connection of the injection nozzle 7 with the collecting vessel 1 can be carried out, for example, by means of the union (not shown in the drawings).

Sealing means 17 can be made from an elastic material such as elastoplast, rubber, dryflex or santopren.

As a filter material 5 for the replaceable filter module 4 one can use fine dispersive sorbents, filter materials of fine or coarse purification, namely: granulated activated carbons with particles of 0.100-3 mm in size; powder activated carbons with particles of 0.005-0.200 mm in size; carbon sulfates with particles of 0.005-3 mm in size; activated carbon fibers, granulated and powder synthetic ion-exchange resins (cation-exchange, anion-exchange, chelating resins and similar) with particles of 0.005-3 mm in size, fibrous filter materials based on synthetic, chemical and natural fibers (for example, polyacrilic, polyolefin, polyester, polyamide, cellulose and etc.) with fibers of 0.005-0.500 mm in diameter, 0.010-30 mm in length, fibrous ion-exchange materials with fibers of 0.005-0.500 mm in diameter, 0.010-30 mm in length, inorganic materials including filter ones correcting pH, sorption and catalytic materials intended for removing specific contaminations, antiscalants, mineralization additives (sands, zeolites, silica gels), materials on the base of the metal oxides and hydroxides (alumina, iron, manganese, antimony, etc.), carbonates of alkaline-earth, etc. (with particles of 0.005-3 mm in size), membrane filtration materials, hollow fiber filter materials, carbonblock filter elements and polymer filter material, comprising nanotubes or any of their combination. Filter material 5 for the replaceable filter module 4 can additionally comprise bactericide additive, for example, in the form of silver salts. Filter module can consist of several parts comprising various filter materials. For example, filter module 4 filled with a filter material 5 is made with the lower part 19 consisting of the polymer hollow fibers or non-fabric polymer material including nanotubes (FIG. 7).

In the particular case of implementation of the device for purifying a liquid, an air purification filter (not shown in the drawings) for trapping aerosols of organic substances and impurities of the weighted particles from air (service element) can be mounted at the input of the pneumatic pump 9.

In the particular case of implementation of the device for purifying a liquid, the collecting vessel 3 for the purified liquid additionally comprises a heating element 20 (FIG. 4) which can be connected to the supply source 11 through the control unit 10. It is possible to use a heating element 20 for heating drinking water in the collecting vessel 3 at the request of the consumer (service element).

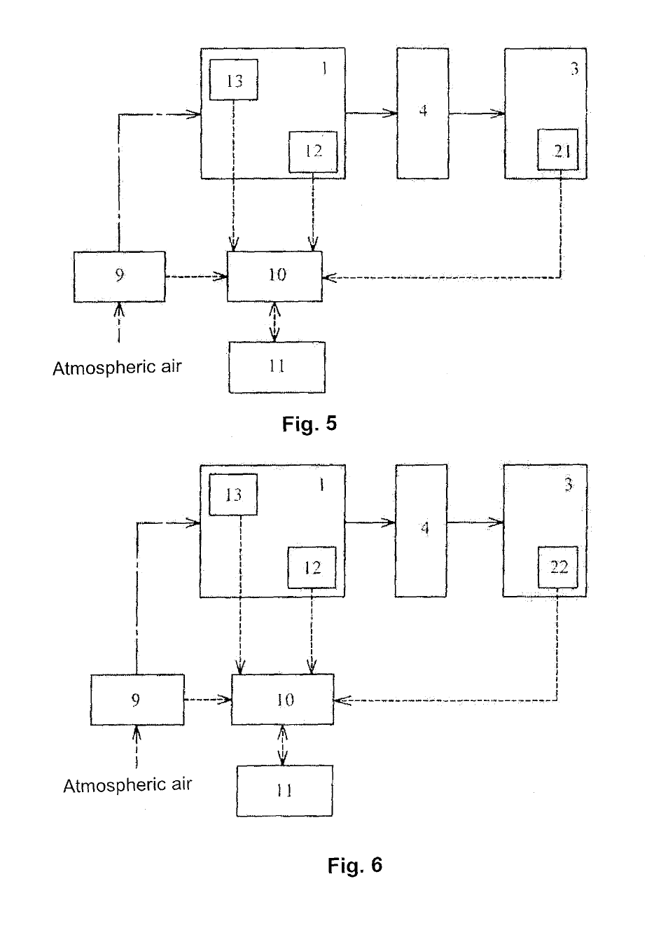

In the particular case of implementation of the device for purifying a liquid, the collecting vessel 3 for the purified liquid additionally comprises an ultraviolet source 21 (FIG. 5) which can be connected to the supply source 11 through the control unit 10. It is possible to use an ultraviolet source 21 for additional disinfection of drinking water at the request of the consumer (service element).

In the particular case of implementation of the device for purifying a liquid, the collecting vessel 3 for the purified liquid additionally comprises a mineralization means 22 (FIG. 6) which can be connected to the supply source 11 through the control unit 10. It is possible to use a mineralization means 22 for additional mineralization of drinking water at the request of the consumer. As mineralization means 22 one can use, for example, a dosing device comprising solid soluble tablets of mineral salts (service element).

The device for purifying a liquid operated as follows.

The collecting vessel 1 is filled with the unpurified liquid through the upper neck 16. The neck 16 is closed with the cover 2 by means of screw joint, bayonet joint or by latching. “Switching-on” button (not shown in the drawings) included as a component in the control unit 10, operates automatically or manually, when closing the cover 2, in consequence the electric circuit closes, and the pneumatic pump 9 begins forced supply atmospheric air into the collecting vessel 1 above the level 23 of the unpurified liquid through the injection nozzle 7 (FIG. 7). In this case the pressure regulating valve 8 is closed. Under the action of the arising positive air pressure, a liquid from the collecting vessel 1 begins forced flow through the replaceable filter module 4 filled with a filter material 5. Throughout the entire filtration cycle, the automatic means 6 for timed air injection during the filtration regime maintains excess pressure above the level 23 of the unpurified liquid within the specified range. Stabilization of the positive air pressure ensures uniform and stable flowing of the liquid and accordingly effective use of the filter material 5, i.e., contributes to increasing the liquid purification degree.

A liquid flowing through the replaceable filter module 4 and enters the collecting vessel 3 for the purified liquid. On achieving the magnitude of excess pressure ≧1.0 bar, preferably ≧0.5 bar the feedback means 13 applies a signal of switching-off of the pneumatic pump 9 to the control unit 10. In the process of filtration as a liquid flowing through the filter module 4, positive air pressure gradually decreases. At the magnitude of excess pressure of ≦0.1 bar, preferably ≦0.15 bar, a feedback means 13 applies a signal of switching-off of the pneumatic pump 9 to the control unit 10. Pneumatic pump 9 begins to pump atmospheric air into the collecting vessel 1 through the injection nozzle 7 up to obtaining the required value of excess pressure, after that the control unit 10 holds up operation of the pneumatic pump 9 again and so on. Periodic switching-on and switching-off of the pneumatic pump 9 ensures interruptions in its operation which allows decreasing energy cost of the power supply 11. Maintaining in this way the magnitude of positive air pressure above the level of the unpurified liquid within the specified range contributes to uniform and stable flowing of a liquid through the replaceable filter module 4 and allows increasing the liquid filtration speed throughout the entire filtration cycle.

FIG. 7 schematically shows the level 23 of the unpurified liquid in the collecting vessel 1 in the initial moment of filtration cycle. The liquid level sensor 12, for example, arranged in the lower part of the collecting vessel 1 at the level corresponding to the minimal level of fill-up of the collecting vessel 1, in occurring the liquid level at corresponding minimal level, operates and applies a signal of finishing of filtration cycle to the control unit 10. The control unit 10 switches off the pneumatic pump 9. Pressure regulating valve 8 releases positive air pressure within the collecting vessel 1 for the unpurified liquid. Regulating valve 8 can release pressure automatically or in response to a signal from the control unit 10.

In consequent closing of the button “switching-on” filtration cycle repeats. In this case, operation of every new cycle begins independently on that whether the collecting vessel 1 is filled with a liquid fully or if only partly.

The particular implementation of the device for purifying a liquid is defined by quality of an initial liquid and requirements made on purity and quality of the liquid to be obtained.

Using of the device for purifying a liquid allows increasing the liquid filtration speed and simultaneously increasing the liquid purification degree thanks to maintaining the magnitude of positive air pressure above the level of the unpurified liquid within the specified range of pressures throughout the entire filtration cycle by means of the automatic means of timed injection of air in filtration regime allowing maintaining a stable, unlike the prototype, magnitude of positive air pressure above the level of the unpurified liquid throughout the entire filtration cycle which ensures uniform and stable flowing of a liquid through the replaceable filter module contributing the effective use of fine dispersive sorbents and filter materials of fine purification.

The device for purifying a liquid has improved operational characteristics, unlike the prototype. The proposed device has a compact dimension and a small weight. In operation of the device, noise, vibrations do not arise, and filtration process will not entail the expenditures of some physical efforts on the consumer's part. The device is portable, very simple and convenient in operation.

One should understand that this invention is not limited to the disclosed embodiment, but on contrary, it encompasses various modifications and embodiments within the spirit and scope of the appended claims.

1. A device for purifying a liquid, the device comprising:
a collecting vessel for an unpurified liquid;
a collecting vessel for a purified liquid;
a replaceable filter module filled with a filter material; and
an automatic means for timed injection of air into the collecting vessel for the unpurified liquid during a filtration process, said automatic means being connected to the collecting vessel for the unpurified liquid by an injection nozzle having a pressure control valve, wherein said automatic means is further for maintaining positive air pressure above the unpurified liquid during the filtration process.

2. The device for purifying a liquid according to claim 1, wherein the automatic means for timed injection of air includes a pneumatic pump, a control unit, a power supply, a liquid level sensor and at least one feedback means, wherein an input of the pneumatic pump is communicated with atmosphere, and an output of the pneumatic pump is connected to an input of the control unit designed to define sequence and temporal modes of operation of the pneumatic pump during the filtration process, an output of the control unit is connected to an input of the power supply, and the liquid level sensor and the at least one feedback means are connected to the control unit.

3. The device for purifying a liquid according to claim 2, wherein a pressure pickup or a current sensor or an effort sensor or a combination of two or more thereof is used as a feedback means.

4. The device for purifying a liquid according to claim 2, wherein an air microcompressor is used as the pneumatic pump.

5. The device for purifying a liquid according to claim 2, wherein a membrane micropump is used as the pneumatic pump.

6. The device for purifying a liquid according to claim 1, wherein the pressure control valve is used for releasing positive air pressure within the collecting vessel for the unpurified liquid on finishing the filtration process.

7. The device for purifying a liquid according to claim 2, wherein the liquid level sensor is designed for automatic switching off of the pneumatic pump depending on a level of the unpurified liquid.

8. The device for purifying a liquid according to claim 7, wherein the liquid level sensor is used for automatic switching off of the pneumatic pump at a minimal level of the unpurified liquid.

9. The device for purifying a liquid according to claim 3, wherein the feedback means is for maintaining a magnitude of the positive air pressure above the unpurified liquid within a range of 0.1 bar-1.0 bar.

10. The device for purifying a liquid according to claim 7, wherein a float sensor or a conductance sensor or a contactless sensor is used as the liquid level sensor.

11. The device for purifying a liquid according to claim 7, wherein a conductance sensor is used as the liquid level sensor.

12. The device for purifying a liquid according to claim 7, wherein a contactless sensor is used as the liquid level sensor.

13. The device for purifying a liquid according to claim 1, wherein the injection nozzle is further provided with a protection valve designed for equalizing excess positive air pressure in the collecting vessel for the unpurified liquid.

14. The device for purifying a liquid according to claim 2, wherein an air purification filter is further arranged at the input of the pneumatic pump.

15. The device for purifying a liquid according to claim 1, wherein the collecting vessel for the purified liquid further comprises a heating element.

16. The device for purifying a liquid according to claim 1, wherein the collecting vessel for the purified liquid further comprises an ultraviolet source.

17. The device for purifying a liquid according to claim 1, wherein the collecting vessel for the purified liquid further comprises a mineralization means.

18. The device for purifying a liquid according to claim 1, wherein granulated activated carbon, powder activated carbon, granulated ion-exchange resin, powder ion-exchange resin, activated carbon fibers, polymer ion-exchange fibers, membrane filtration elements, hollow fiber filtration elements, and carbonblock filtration elements and polymer filter material comprising nanotubes, or a combination of two or more thereof, are used as the filter material for the replaceable filter module.

19. The device for purifying a liquid according to claim 18, wherein the filter material for the replaceable filter module further comprises a bactericide additive.

20. The device for purifying a liquid according to claim 3, wherein the feedback means is for maintaining a magnitude of the positive air pressure above the unpurified liquid within a range of 0.15 bar-0.5 bar.
